(19) United States
(12) Patent Application Publication
(10) Pub. No.: US 2024/0406327 A1
(43) Pub. Date: Dec. 5, 2024

(54) IMAGE READING DEVICE, IMAGE FORMING APPARATUS, AND IMAGE READING METHOD

(71) Applicant: Hirofumi ONO, KANAGAWA (JP)

(72) Inventor: Hirofumi ONO, KANAGAWA (JP)

(21) Appl. No.: 18/673,357

(22) Filed: May 24, 2024

(30) Foreign Application Priority Data
Jun. 1, 2023 (JP) 2023-091242

(51) Int. Cl. H04N 1/00; H04N 1/60

(52) U.S. Cl. CPC H04N 1/00835; H04N 1/6005

(57) ABSTRACT

An image reading device includes a first light source, a first image sensor, a second light source, a second image sensor, and processing circuitry. The first light source irradiates an object with light in a first wavelength range. The first image sensor receives light reflected by the object and output a first image. The second light source irradiates the object with light in a second wavelength range different from the first wavelength range of the first light source. The second image sensor receives light reflected by the object and output a second image. The processing circuitry calculates signal levels of the first and second image, controls light amounts of the first and second light source respectively based on the calculated signal levels, and detects abnormal lighting of the first or second light source corresponding to the first or second image sensor.

### CROSS-REFERENCE TO RELATED APPLICATIONS

This patent application is based on and claims priority pursuant to 35 U.S.C. § 119 (a) to Japanese Patent Application No. 2023-091242, filed on Jun. 1, 2023, in the Japan Patent Office, the entire disclosure of which is hereby incorporated by reference herein.

### BACKGROUND

### Technical Field

The present disclosure relates to an image reading device, an image forming apparatus, and an image reading method.

### Related Art

A technique is known that abnormal lighting of a visible light source is detected based on a result of comparison between difference data obtained by subtracting a minimum value of a dark-time output level from a maximum value of the dark-time output level read when the visible light source is turned off and a dark-time output level serving as a reference.

### SUMMARY

Embodiments of the present disclosure described herein provide a novel image reading device including a first light source, a first image sensor, a second light source, a second image sensor, and processing circuitry. The first light source irradiates an object with light in a first wavelength range. The first image sensor receives light emitted from the first light source to and reflected by the object and output a first image. The second light source irradiates the object with light in a second wavelength range different from the first wavelength range of the first light source. The second image sensor receives light emitted from the second light source to and reflected by the object and output a second image. The processing circuitry calculates signal levels of the first image and the second image. The processing circuitry controls light amounts of the first light source and the second light source respectively based on the calculated signal levels. The processing circuitry detects abnormal lighting of one of the first light source and the second light source corresponding to one of the first image sensor and the second image sensor that performs a predetermined operation.

Embodiments of the present disclosure described herein provide a novel image forming apparatus including the image reading device and an image forming device to form an image.

Embodiments of the present disclosure described herein provide a novel image reading method executed by an image reading device. The method includes: with a first light source, irradiating an object with light in a first wavelength range; with a first image sensor, receiving light emitted from the first light source to and reflected by the object to output a first image; with a second light source, irradiating the object with light in a second wavelength range different from the first wavelength range of the first light source; with a second image sensor, receiving light emitted from the second light source to and reflected by the object to output a second image; calculating signal levels of the first image and the second image; controlling light amounts of the first light source and the second light source respectively based on the calculated signal levels; and detecting abnormal lighting of one of the first light source and the second light source corresponding to one of the first image sensor and the second image sensor that performs a predetermined operation.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an image processing apparatus according to a first embodiment;

FIG. 2 is a diagram illustrating a configuration of an image reading device;

FIG. 3 is a diagram illustrating control blocks of the image reading device;

FIG. 4 is a diagram illustrating a spectral sensitivity characteristic of an image sensor;

FIG. 5 is a schematic diagram illustrating a functional configuration to detect abnormality in an invisible light source;

FIG. 6 is a flowchart of a process of detecting abnormal lighting of an invisible light source at the time of initial adjustment of a visible light reading unit;

FIG. 7 is a flowchart of a process of detecting abnormal lighting of a visible light source at the time of initial adjustment of an invisible light reading unit, according to a second embodiment;

FIG. 8 is a flowchart of a process of detecting abnormal lighting of an invisible light source at the time of adjustment of a visible light reading unit, according to a third embodiment; and

FIG. 9 is a flowchart of a process of detecting abnormal lighting of an invisible light source before reading is performed by a visible light reading unit, according to a fourth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of an image reading device, an image forming apparatus, and an image reading method according to several embodiments of the present disclosure with reference to the drawings.

### First Embodiment

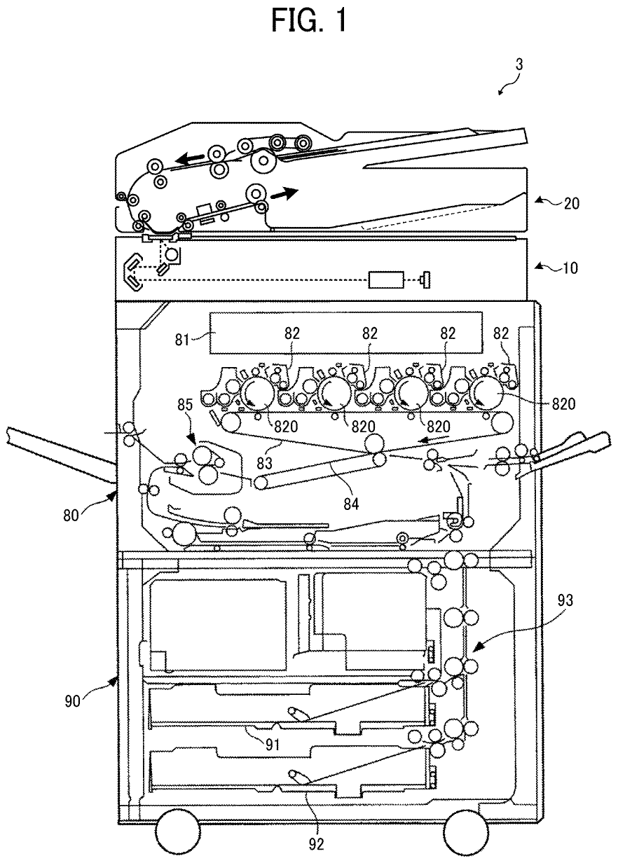

FIG. 1 is a diagram illustrating a configuration of an image processing apparatus 3 according to a first embodiment of the present disclosure. FIG. 1 illustrates an example of the image forming apparatus 3 that is generally referred to as a multifunction peripheral, a multifunction printer, or a multifunction product (MFP). The MFP includes at least two of a copy function, a printer function, a scanner function, and a facsimile function. The image forming apparatus 3 illustrated in FIG. 1 includes an image reading device 1 in an upper portion of the image forming apparatus 3. The image reading device 1 includes an image reading device main body 10 and an automatic document feeder (ADF) 20.

The image forming apparatus 3 illustrated in FIG. 1 includes an image forming device 80 and a sheet feeding device 90 below the image reading device main body 10.

The image forming device 80 prints the image data read by the image reading device main body 10 on a recording sheet which is an example of a recording medium. The read image data is visible image data or near-infrared image data. The visible image data and the near-infrared image data are described in detail later.

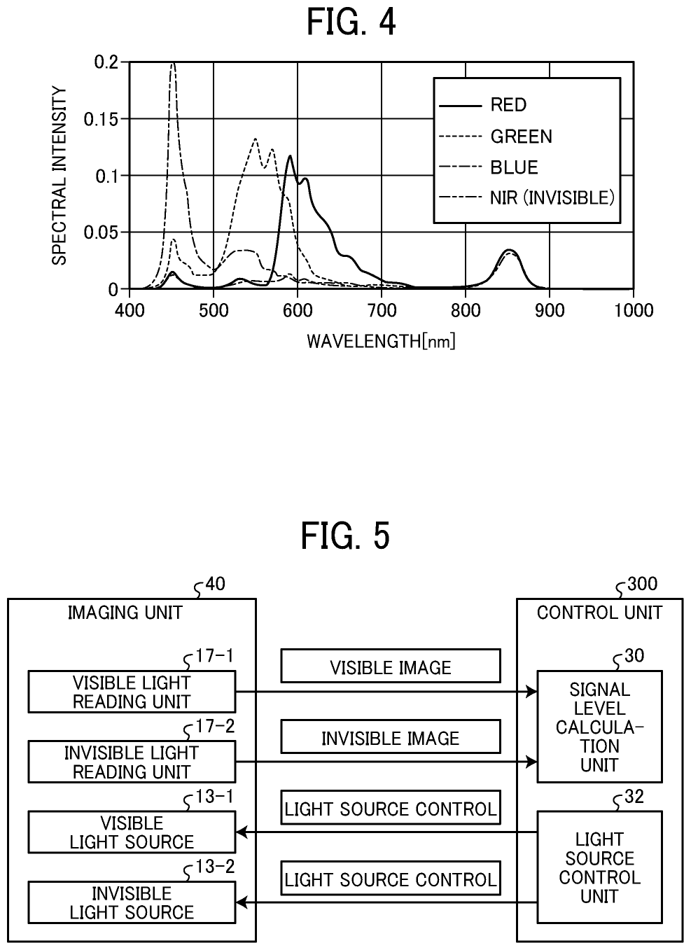

The “visible image data” indicates visible image data that is read by a sensing device such as an image sensor having sensitivity to light (visible light) of a light source in a visible wavelength range, for example, the range of 400 nm to 700 nm. The visible image data may be referred to simply as a visible image in the following description. The “invisible image data” indicates image data that is read by a sensing device such as an image sensor having sensitivity to light of a light source in an invisible wavelength range other than the visible wavelength range, such as infrared light (including near-infrared) or ultraviolet light. In the following description, near-infrared image data (the near-infrared image data may be referred to simply as a near-infrared image) indicates an example of the “invisible image data”. However, the invisible image data is not limited to the near-infrared image. An example in which near-infrared light is used as invisible light is described below (see FIG. 4).

The image forming device 80 includes, for example, an optical writing device 81, image forming units 82 (yellow (Y), magenta (M), cyan (C), and black (K)) that are tandem type, an intermediate transfer belt 83, and a secondary transfer belt 84. In the image forming device 80, the optical writing device 81 writes an image to be printed on each photoconductor drum 820 of the image forming units 82, and toner images of the yellow, magenta, cyan, and black plates are transferred from the photoconductor drums 820 onto the intermediate transfer belt 83. The black (K) plate is formed of a black (K) toner including carbon black.

The image forming units 82 (Y, M, C, and K) include rotatable photoconductor drums 820 (Y, M, C, and K), respectively. Each of the image forming units 82 includes image forming elements including a charging roller, a developing device, a primary transfer roller, a cleaner unit, and a static eliminator around the photoconductor drum 820. The image forming elements are operated around each of the photoconductor drums 820 in predetermined image forming processes to form an image on each of the photoconductor drums 820. Each primary transfer roller transfers the image formed on each of the photoconductor drums 820 as a toner image onto the intermediate transfer belt 83.

The intermediate transfer belt 83 is provided in the nips between the photoconductor drums 820 and the corresponding primary transfer rollers and is stretched by a driving roller and driven rollers. The intermediate transfer belt 83 conveys the toner image transferred onto the intermediate transfer belt 83 and a secondary transfer device transfers the toner image onto a recording sheet on the secondary transfer belt 84. The secondary transfer belt 84 conveys the recording sheet to a fixing device 85, and then the toner image is fixed as a color image on the recording sheet. After that, the recording sheet is ejected to an output tray provided outside the housing of the image forming apparatus 3.

For example, the sheet feeding device 90 feeds a recording sheet from sheet trays 91 and 92 loading recording sheets having different sheet sizes, and a conveyor 93 including various rollers conveys the recording sheet to the secondary transfer belt 84.

The image forming device 80 is not limited to the one that forms an image by an electrophotographic method as described above, and may be one that forms an image by, for example, an inkjet method. The image forming apparatus is not limited to the MFP. The image forming apparatus may be, for example, a printer that receives image data generated by a separate image processing apparatus through communication and prints the received image data.

A description is now given below of the image reading device 1.

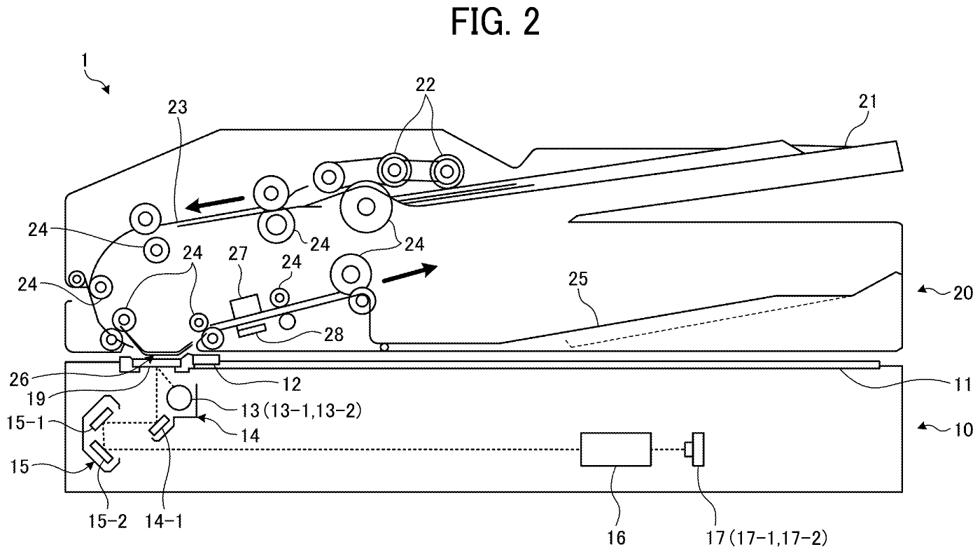

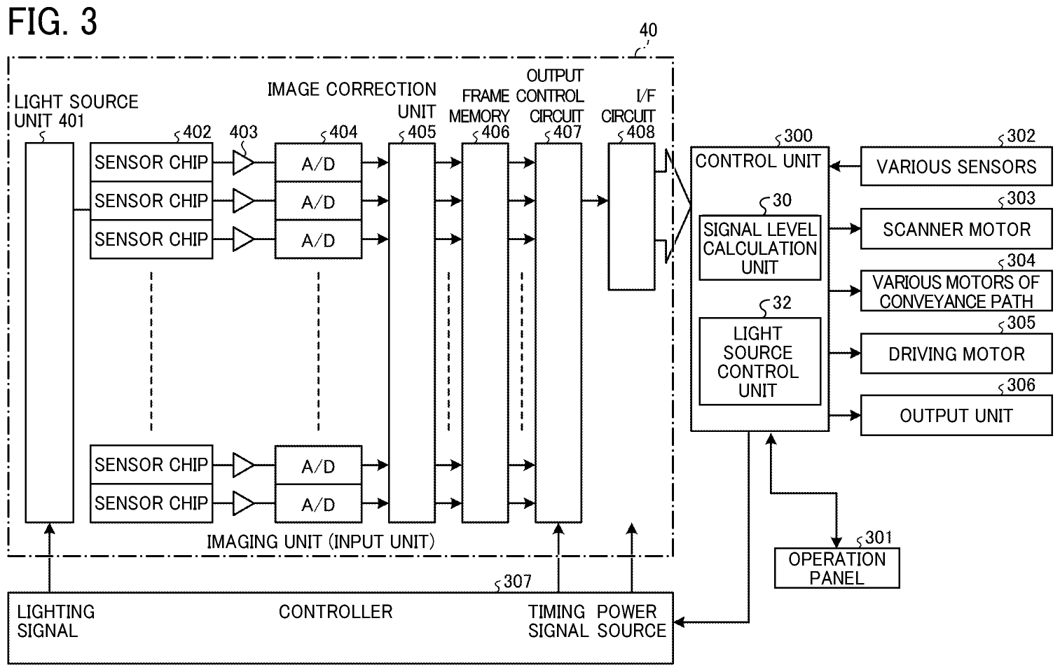

FIG. 2 is a diagram illustrating a configuration of the image reading device 1. As illustrated in FIG. 2, the image reading device main body 10 of the image reading device 1 includes an exposure glass 11 on the upper surface of the image reading device main body 10 and includes an imaging unit 40 (see FIG. 3) inside the image reading device main body 10. A light source 13, a first carriage 14, a second carriage 15, a lens unit 16, and an image sensor 17 are disposed inside the image reading device main body 10. The first carriage 14 includes the light source 13 and a reflection mirror 14-1. The second carriage 15 includes reflection mirrors 15-1 and 15-2. The image reading device main body 10 includes a control board. The control board is an example of the control unit 300 illustrated in FIG. 3, and controls the overall image reading device 1.

The control board irradiates an object to be read with the light from the light source 13 while moving the first carriage 14 and the second carriage 15, and sequentially reads the light reflected by the object to be read placed on the exposure glass 11 using the image sensor 17. When the light source 13 irradiates the object to be read with light, the light reflected by the object to be read is reflected by the reflection mirror 14-1 of the first carriage 14 and the reflection mirrors 15-1 and 15-2 of the second carriage 15 and enters the lens unit 16. The light that exits from the lens unit 16 forms an image on the image sensor 17. The image sensor 17 receives the light reflected by the object to be read and outputs an image signal.

The image sensor 17 is an image sensor such as a charge-coupled device (CCD) or a complementary metal-oxide semiconductor (CMOS), and corresponds to a reading unit that reads an image of the object to be read.

The light source 13 includes a visible light source 13-1 as a second light source and an invisible light source 13-2 as a first light source. The image sensor 17 includes a visible light reading unit 17-1 as a second reading unit and an invisible light reading unit 17-2 as a first reading unit. In this example, the visible light reading unit 17-1 is a visible light image sensor as a first image sensor, and the invisible light reading unit 17-2 is an invisible light image sensor as a second image sensor. The visible light reading unit 17-1 receives the visible light reflected by the object to be read and outputs an image. The invisible light reading unit 17-2 receives the near-infrared light reflected by the object to be read and outputs an image. An image received by irradiating the object to be read with visible light is referred to as a visible image, and an image received by irradiating the object to be read with near-infrared light is referred to as a near-infrared image. Although the visible light source 13-1 and the invisible light source 13-2 are separately provided as light sources. However, a single light source may be provided.

The visible light reading unit 17-1 and the invisible light reading unit 17-2 may be configured by one image sensor or may be configured by separate image sensors as long as the visible light reading unit 17-1 and the invisible light reading unit 17-2 can output a visible image and a near-infrared image, separately.

A reference white plate 12 is a member to perform white correction.

The image reading device 1 illustrated in FIG. 2 includes the ADF 20. The ADF 20 opens upward when one side is lifted upward, and the surface of the exposure glass 11 is exposed. A user sets the object to be read on the exposure glass 11, lowers the ADF 20, and presses the ADF 20 against the surface of the exposure glass 11 from the back surface of the object to be read. When a scan start key or button is touched or pressed, the first carriage 14 and the second carriage 15 are driven to move in the main scanning direction and the sub-scanning direction to scan the overall object to be read.

In addition to the method of reading the object to be read set on the exposure glass 11, the object to be read can be read by the following method. The ADF 20 also can read the object to be read by a sheet-through method. In the ADF 20, a pickup roller 22 separates a stack of objects to be read one by one from a tray 21 in the ADF 20, and one side or both sides of an object to be read that is conveyed on a conveyance path 23 by control of various conveyance rollers 24 are read and ejected to an ejection tray 25.

The reading of the object to be read by the ADF 20 in the sheet-through method is performed through a reading window 19. In this example, the first carriage 14 and the second carriage 15 are moved to and fixed at a predetermined home position. When the object to be read passes between the reading window 19 and a background portion 26, the front surface of the object to be read facing the reading window 19 is irradiated with the light from the light source 13 to read an image. The reading window 19 is a slit-shaped reading window formed on a part of the exposure glass 11. The background portion 26 is a background member.

When both sides of the object to be read are to be scanned in the ADF 20, after the object passes by the reading window 19, the back surface of the object is read by a reading module 27 of the second reading unit provided to face the back surface of the object. The reading module 27 includes an irradiation unit including a light source and a contact image sensor serving as a second reading unit. The contact image sensor reads the light emitted to and reflected by the second surface. The light source may also include a visible light source and an invisible light source so that a visible image and a near-infrared image can be read.

The background member 28 is a density reference member.

A description is given below of a configuration of a control block of the image reading device 1.

FIG. 3 is a diagram illustrating control blocks of the image reading device 1. As illustrated in FIG. 3, the image reading device 1 includes a control unit 300, an operation panel 301, various sensors 302, a scanner motor 303, various motors 304 in the conveyance path, a driving motor 305, an output unit 306, and the imaging unit 40. In addition, various objects to be controlled are connected. The various sensors 302 are sensors that detect an object to be read. The scanner motor 303 is a motor that drives the first carriage 14 and the second carriage 15 of the image reading device main body 10. The various motors 304 in the conveyance path are various motors disposed in the ADF 20. The output unit 306 corresponds to an output interface for the control unit 300 to output an image data to an external device. The output interface may be an interface such as a universal serial bus (USB) or a communication interface for connecting to a network.

The operation panel 301 is, for example, a liquid crystal display device of a touch screen type. The operation panel 301 receives input operations such as various settings and reading execution (scan execution) from the user through operation keys or touch input and transmits corresponding operation signals to the control unit 300. The operation panel 301 displays various kinds of display information from the control unit 300 on a display screen. For example, the operation panel 301 includes various setting keys or buttons for removing a seal impression of a seal that is applied on the object to be read by the user, and instructs the control unit 300 to change settings when an input operation is made through the setting key or button. Whether to remove a seal impression may be selected on a setting screen of the display screen. A setting may be made such that a seal impression is removed when a key to perform scanning is operated. Various data used for removing the seal impression may be stored in an external memory or output to an external device.

The imaging unit 40 corresponds to an input unit. The imaging unit 40 includes a light source 401, sensor chips 402, amplifiers 403, analog-to-digital (A/D) converters 404, an image correction unit 405, a frame memory 406, an output control circuit 407, and an I/F circuit 408. The image data that is read from the object to be read is output from the output control circuit 407 to the control unit 300 through the I/F circuit 408 on a frame-by-frame basis. The sensor chips 402 are the pixel sensors disposed in the image sensor 17. The light source 401 is the light source 13.

The imaging unit 40 is controlled by a controller 307. For example, the imaging unit turns on the light source 401 based on a turn-on signal from the controller 307 and irradiates the object to be read with visible light and near-infrared light at a set timing. The imaging unit 40 converts the light that is reflected by an object to be read and forms an image on the sensor surface of the image sensor 17 into an electric signal by each sensor chip 402, and outputs the electric signal.

The imaging unit 40 amplifies the electrical signal (pixel signal) output from the sensor chips 402 by the amplifiers 403, converts the analog signal into a digital signal by the A/D converters 404, and outputs a level signal of the pixel. The image correction unit 405 performs image correction on an output signal from each pixel. For example, the image correction unit 405 performs shading correction on an output signal from each pixel.

After the image correction, data is stored in the frame memory 406, and the stored read image is transferred to the control unit 300 through the output control circuit 407 and the I/F circuit 408.

The control unit 300 includes a central processing unit (CPU) and a memory, and the CPU controls the overall device to perform a reading operation on the object to be read and to execute a process such as the removal of a seal impression on a read image obtained by the reading operation.

The control unit 300 includes a signal level calculation unit 30 and a light source control unit 32. The signal level calculation unit 30 and the light source control unit 32 can be implemented by functional units that are implemented by the CPU executing predetermined programs. Alternatively, hardware such as an application-specific integrated circuit (ASIC) can also implement the signal level calculation unit 30 and the light source control unit 32. The signal level calculation unit 30 and the light source control unit 32 will be described in detail later.

A description is given below of the shading correction executed by the image correction unit 405 of the image reading device 1.

For example, one of the initial adjustments performed when the image reading device 1 is powered on is the generation of black shading data. The black shading is a process performed to cancel fixed pattern noise of the image sensor 17 of the image reading device 1 regardless of the level of the received light. Black shading data KO is data serving as a reference for canceling fixed pattern noise of the image sensor 17 of the image reading device 1.

The acquisition of the black shading data is to acquire the level of the output data of the image sensor 17 in a state where no light enters the image sensor 17 of the image reading device 1 (dark-time output level). When light enters the image sensor 17 in a case where the black shading data is acquired, the level of the output data of the image sensor 17 becomes higher than the original dark-time output level.

The black shading is a process of subtracting the black shading data from the output value of the image sensor 17 as in the following equation.

$$D 1 ( data after processing ) = D 0 - K 0$$

When the black shading data of the visible light reading unit 17-1 that receives the reflected light of the visible light from the visible light source 13-1 is generated, the invisible light source 13-2 may be turned on for some reason.

FIG. 4 is a diagram illustrating a spectral sensitivity characteristic of the image sensor 17. As illustrated in FIG. 4, the characteristic of “RED” of the image sensor 17 indicates that the image sensor 17 has sensitivity in the invisible wavelength range (about 800 to 900 nanometers (nm)). Accordingly, a difference is generated between a result of reading by lighting the visible light source 13-1 alone and a result of reading by lighting both the visible light source 13-1 and the invisible light source 13-2.

In other words, when the invisible light source 13-2 is turned on and the black shading data of the visible light reading unit 17-1 is generated, the black shading data is affected by the invisible light source 13-2 and becomes larger than the original level. When the black shading data affected by the invisible light source 13-2 is subtracted from the output value of the image sensor 17, an abnormal image tends to be generated as an image becomes darker than the image data originally intended to be obtained or the image is affected by unintended noise.

For this reason, when the reading operation is performed with the visible light source 13-1 turned on alone or when various adjustments are performed with the visible light source 13-1 turned off, the invisible light source 13-2 is desired to be turned off with reliability.

In the present embodiment, before the black shading data of the visible light reading unit 17-1 that receives the reflected light of the visible light from the visible light source 13-1 is generated, abnormality in the lighting of the invisible light source 13-2 is detected. Since abnormality in the lighting of the invisible light source 13-2 is detected before the black shading data of the visible light reading unit 17-1 that receives the reflected light of the visible light from the visible light source 13-1 is generated, the black shading can be correctly performed, and the occurrence of an abnormal image can be reduced.

In the present embodiment, the acquisition of the black shading data is described as the initial adjustment of the visible light reading unit 17-1. However, the initial adjustment of the visible light reading unit 17-1 is not limited to the acquisition of the black shading data, and the initial adjustment of the visible light reading unit 17-1 includes light amount adjustment for setting the light amount of the light source 13 and gain adjustment for adjusting the magnification ratio so that the output level of the visible light reading unit 17-1 when the reference white plate 12 is read is adjusted to a target value.

FIG. 5 is a schematic diagram illustrating a functional configuration to detect abnormality in the invisible light source 13-2.

The imaging unit 40 includes a pair of the visible light source 13-1 and the visible light reading unit 17-1 and a pair of the invisible light source 13-2 and the invisible light reading unit 17-2, which are described above with reference to FIG. 3. The imaging unit 40 irradiates the object to be read with the light from the visible light source 13-1, receives the light reflected by the object to be read with the visible light reading unit 17-1, and outputs a visible image (e.g., a red, green, and blue (RGB) image).

The imaging unit 40 irradiates the same object to be read with the light from the invisible light source 13-2, receives the light reflected by the object to be read with the invisible light reading unit 17-2, and outputs an invisible image (near-infrared (NIR) image).

The imaging unit 40 can simultaneously read both the visible image and the near-infrared image from the same object to be read. When the object to be read is the same, the imaging unit 40 does not need to read both the visible image and the near-infrared image at the same time, and may read the images at different timings as long as the positions of the objects to be imagined match.

The signal level calculation unit 30 receives the visible image and the invisible image imaged by the imaging unit 40. The signal level calculation unit 30 calculates the signal levels of the visible image and the invisible image imaged by the imaging unit 40.

The light source control unit 32 determines whether the invisible light source 13-2 is turned on based on the signal level calculated by the signal level calculation unit 30 before the start of the initial adjustment of the visible light reading unit 17-1. In the present embodiment, the light source control unit 32 compares the output level of the invisible light reading unit 17-2 that reads the reflected light of the invisible light source 13-2 that is not turned on with a reference value to determine whether the invisible light source 13-2 is turned on. When the light source control unit 32 determines that the invisible light source 13-2 is not turned on, the light source control unit 32 turns on the visible light reading unit 17-1 alone to perform initial adjustment (e.g., acquisition of black shading data).

On the other hand, when the light source control unit 32 determines that the invisible light source 13-2 is turned on, the light source control unit 32 provides notification of abnormal lighting of the invisible light source 13-2. For example, the light source control unit 32 displays an error notification (error number) on the operation panel 301 or turns on a red lamp provided on the operation panel 301 to provide notification of abnormal lighting of the light source.

A description is given below of a processing flow of detecting abnormal lighting of the invisible light source 13-2, at the time of initial adjustment of the visible light reading unit 17-1, which is an example of a predetermined operation.

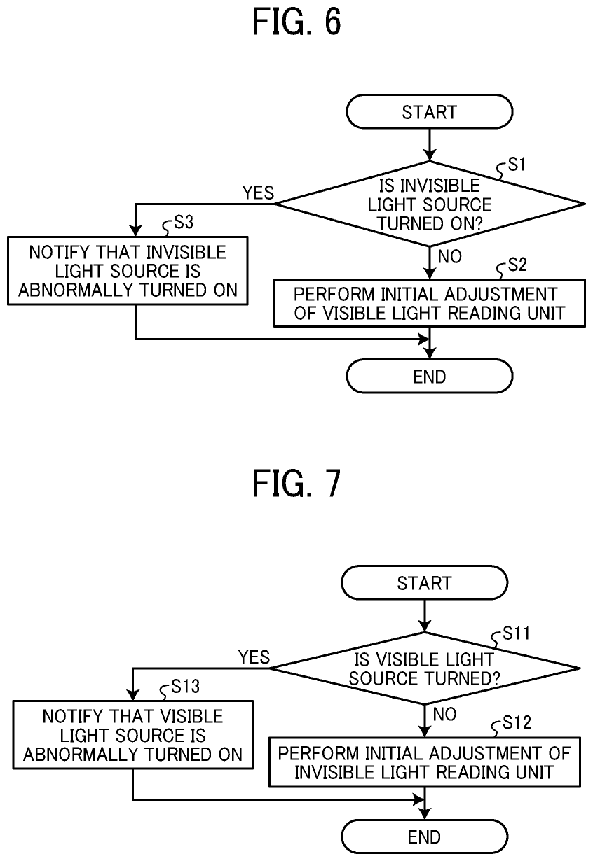

FIG. 6 is a flowchart of a process of detecting the abnormal lighting of the invisible light source 13-2 at the time of initial adjustment of the visible light reading unit 17-1. As illustrated in FIG. 6, the light source control unit 32 determines whether the invisible light source 13-2 is turned on based on the signal level calculated by the signal level calculation unit 30 before the start of the initial adjustment of the visible light reading unit 17-1 (step S1).

When the light source control unit 32 determines that the invisible light source 13-2 is not turned on (NO in step S1), the light source control unit 32 performs initial adjustment of the visible light reading unit 17-1 (step S2).

On the other hand, when the light source control unit 32 determines that the invisible light source 13-2 is turned on (YES in step S1), the light source control unit 32 provides notification of abnormal lighting of the invisible light source 13-2 (step S3).

As described above, according to the present embodiment, when a plurality of types of light sources such as the visible light source 13-1 and the invisible light source 13-2 are provided and the visible light source 13-1 is turned on alone, the image reading device 1 can detect abnormal lighting of the invisible light source 13-2. As a result, the image reading device 1 can reduce the occurrence of an abnormal image and reduce the effect on the initial adjustment of the visible light source 13-1. In other words, in an image reading device having a plurality of types of light sources having different wavelength ranges, the image reading device can detect abnormal lighting of the light source to reduce the occurrence of an abnormal image.

The light source control unit 32 compares the output level of the invisible light reading unit 17-2 which reads the reflected light of the invisible light source 13-2 which is not turned on with the reference value to determine whether the invisible light source 13-2 is turned on and detect the abnormal lighting. As a result, the occurrence of the abnormal image can be reduced.

### Second Embodiment

Next, a description is given of a second embodiment of the present disclosure.

The second embodiment is different from the first embodiment in that abnormal lighting of the visible light source 13-1 is detected at the time of initial adjustment of the invisible light reading unit 17-2 as a predetermined operation. In the following, descriptions of the configurations equivalent to the configurations of the first embodiment are omitted, and features of the second embodiment different from the first embodiment are mainly described. FIG. 7 is a flowchart of a process for detecting abnormal lighting of the visible light source 13-1 at the time of initial adjustment of invisible light reading unit 17-2, according to the second embodiment.

As illustrated in FIG. 7, the light source control unit 32 determines whether the light source 13-1 is turned on based on the signal level calculated by the signal level calculation unit 30 before the start of the initial adjustment of the invisible light reading unit 17-2 (step S11). In the present embodiment, the light source control unit 32 compares the output level of the visible light reading unit 17-1 that reads the reflected light of the visible light source 13-1 that is not turned on with a reference value to determine whether the visible light source 13-1 is turned on.

When the light source control unit 32 determines that the visible light source 13-1 is not turned on (NO in step S11), the light source control unit 32 performs initial adjustment of the invisible light reading unit 17-2 (e.g., acquisition of black shading data) (step S12).

On the other hand, when the light source control unit 32 determines that the visible light source 13-1 is turned on (YES in step S11), the light source control unit 32 provides notification of abnormal lighting of the visible light source 13-1 (step S13). For example, the light source control unit 32 displays an error notification (error number) on the operation panel 301 or turns on a red lamp provided on the operation panel 301 to provide notification of abnormal lighting of the light source.

As described above, according to the present embodiment, when a plurality of types of light sources such as the visible light source 13-1 and the invisible light source 13-2 are provided and a process is performed by lighting one invisible light source 13-2 alone, the image reading device 1 can detect abnormal lighting of the visible light source 13-1. As a result, the image reading device 1 can reduce the occurrence of an abnormal image and reduce the effect on the initial adjustment of the invisible light source 13-2.

### Third Embodiment

Next, a description is given of a third embodiment of the present disclosure.

The third embodiment is different from the first embodiment in that abnormal lighting of the invisible light source 13-2 is detected at the time of adjustment of the visible light reading unit 17-1 as a predetermined operation. In the following, descriptions of the configurations equivalent to the configurations of the first embodiment are omitted, and features of the third embodiment different from the first embodiment are mainly described.

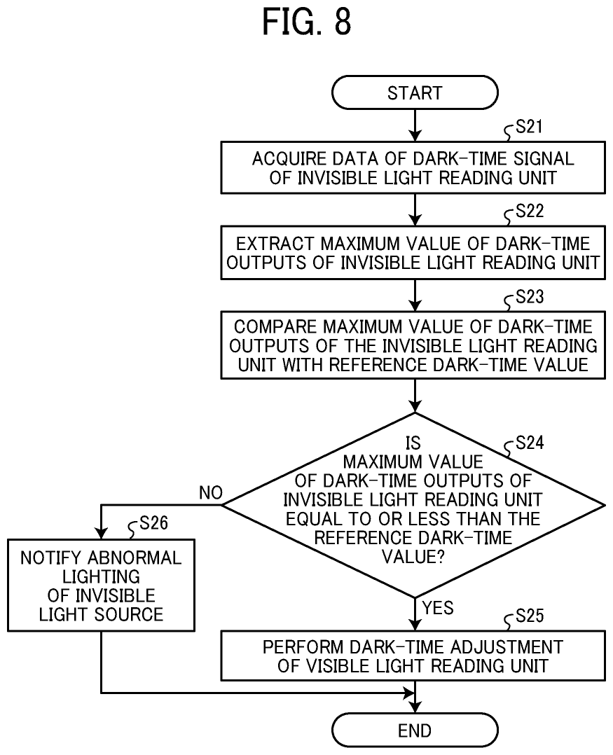

FIG. 8 is a flowchart of a process of detecting abnormal lighting of the invisible light source 13-2 at the time of adjustment of the visible light reading unit 17-1, according to the third embodiment of the present disclosure.

As illustrated in FIG. 8, when a reading job is set for the visible light reading unit 17-1 in a state where the visible light source 13-1 alone is lighted, the light source control unit 32 lights the visible light source 13-1 and then acquires the dark-time output of the invisible light reading unit 17-2 via the signal level calculation unit 30 (step S21).

Subsequently, the light source control unit 32 extracts the maximum value of the dark-time output data of the invisible light reading unit 17-2 (step S22).

Subsequently, the light source control unit 32 compares the maximum value of the dark-time output data of the invisible light reading unit 17-2, which is extracted in step S22, with reference dark-time data (step S23). The reference dark-time data is an abnormal output value of the visible light reading unit 17-1. The reference dark-time data is set as a threshold value instead of acquiring for each machine.

When the maximum value of the dark-time output data of the invisible light reading unit 17-2, which is extracted in step S22, is equal to or less than the reference dark-time data (YES in step S24), the light source control unit 32 determines that the invisible light reading unit 17-2 is normal, and starts dark-time adjustment of the visible light reading unit 17-1 (step S25).

On the other hand, when the maximum value of the dark-time output data of the invisible light reading unit 17-2 extracted in step S22 is not equal to or less than the reference dark-time data (NO in step S24), the light source control unit 32 determines that the invisible light reading unit 17-2 is abnormal, and provides notification of abnormal lighting of the invisible light source 13-2 before performing the dark-time adjustment of the visible light reading unit 17-1 (step S26). For example, the light source control unit 32 displays an error notification (error number) on the operation panel 301 or turns on a red lamp provided on the operation panel 301 to provide notification of abnormal lighting of the light source.

As described above, according to the present embodiment, an adjustment based on the abnormal output data of the visible light reading unit 17-1 can be prevented and the effect of color mixture of invisible light on a visible image can be reduced.

### Fourth Embodiment

Next, a description is given of a fourth embodiment of the present disclosure.

The fourth embodiment is different from the first embodiment in that abnormal lighting of the invisible light source 13-2 is detected before the performance of reading by the visible light reading unit 17-1 as a predetermined operation. In the following, descriptions of the configurations equivalent to the configurations of the first embodiment are omitted, and features of the fourth embodiment different from the first embodiment are mainly described.

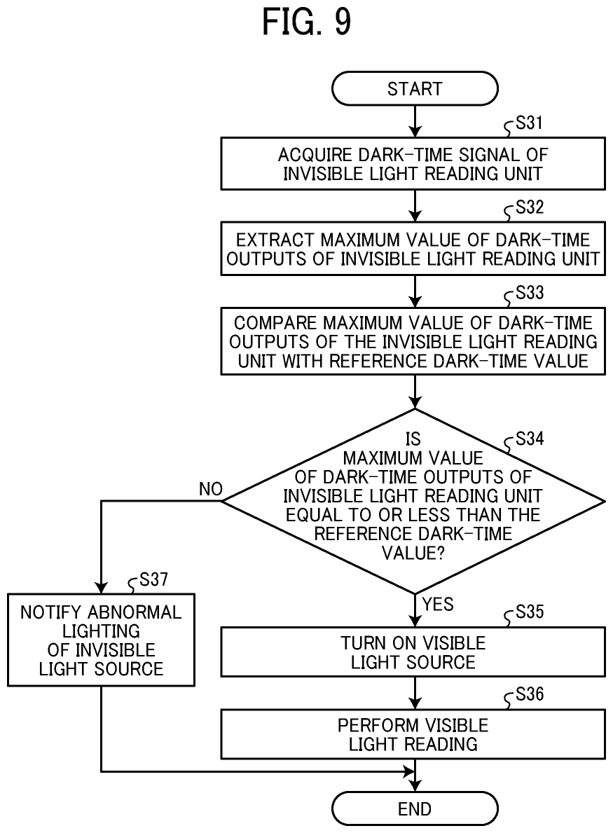

FIG. 9 is a flowchart of a process of detecting abnormal lighting of the invisible light source 13-2 before reading is performed by the visible light reading unit 17-1, according to a fourth embodiment of the present disclosure.

As illustrated in FIG. 9, when the visible light source 13-1 is turned on alone and the visible light reading unit 17-1 performs reading with visible light, the light source control unit 32 turns on the visible light source 13-1 and then acquires the dark-time output of the invisible light reading unit 17-2 via the signal level calculation unit 30 (step S31).

Subsequently, the light source control unit 32 extracts the maximum value of the dark-time output data of the invisible light reading unit 17-2 (step S32).

Subsequently, the light source control unit 32 compares the maximum value of the dark-time output data of the invisible light reading unit 17-2 extracted in step S32 with reference dark-time data (step S33). The reference dark-time data is set as a threshold value instead of acquiring for each machine.

When the maximum value of the dark-time output data of the invisible light reading unit 17-2 extracted in step S32 is equal to or less than the reference dark-time data (YES in step S34), the light source control unit 32 determines that the invisible light reading unit 17-2 is normal, turns on the visible light sources 13-1 (step S35), and performs reading with visible light by the visible light reading unit 17-1 (step S36).

On the other hand, when the maximum value of the dark-time output data of the invisible light reading unit 17-2 extracted in step S32 is not equal to or less than the reference dark-time data (NO in step S34), the light source control unit 32 determines that the invisible light reading unit 17-2 is abnormal, and provides notification of abnormal lighting of the invisible light source 13-2 before the visible light reading unit 17-1 performs reading (step S37). For example, the light source control unit 32 displays an error notification (error number) on the operation panel 301 or turns on a red lamp provided on the operation panel 301 to provide notification of abnormal lighting of the light source.

As described above, according to the present embodiment, since the reception of unintended reflection of light by the visible light reading unit 17-1 can be prevented, the occurrence of an abnormal image can be reduced.

In the above embodiments, the invisible light source 13-2 and the visible light source 13-1 are provided as a plurality of types of light sources (first light source and second light source) having different wavelength ranges, and the invisible light reading unit 17-2 and the visible light reading unit 17-1 are provided as reading units (first reading unit and second reading unit) for reading the reflected light. However, an embodiment of the present disclosure is not limited thereto. For example, a plurality of types of light sources (the first light source and the second light source) having different wavelength ranges may be a plurality of visible light sources or a plurality of invisible light sources as long as the wavelength ranges are different.

In the above embodiments, the image forming apparatus according to the present disclosure is applied to a multifunction printer or multifunction peripheral (MFP) that has at least two of a photocopying function, a printing function, a scanning function, and a facsimile (FAX) function. However, no limitation is intended thereby, and the image forming apparatus according to the present disclosure may be applied to any image forming apparatus such as a copier, a printer, a scanner, and a facsimile.

Although some embodiments of the present disclosure have been described above, the above-described embodiments are presented as examples and are not intended to limit the scope of the present invention. The above-described embodiments can be implemented in other various forms, and various omissions, replacements, and changes can be made without departing from the scope of the present disclosure. In addition, the embodiments and modifications or variations thereof are included in the scope and the gist of the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An image reading device comprising:
a first light source to irradiate an object with light in a first wavelength range;
a first image sensor to receive light emitted from the first light source to and reflected by the object and output a first image;
a second light source to irradiate the object with light in a second wavelength range different from the first wavelength range of the first light source;
a second image sensor to receive light emitted from the second light source to and reflected by the object and output a second image; and
processing circuitry configured to:
calculate signal levels of the first image and the second image;
control light amounts of the first light source and the second light source respectively based on the calculated signal levels; and
detect abnormal lighting of one of the first light source and the second light source corresponding to one of the first image sensor and the second image sensor that performs a predetermined operation.

2. The image reading device according to claim 1, wherein
the first wavelength range of the first light source is an invisible wavelength range,
the light received by the first image sensor is an invisible light in the invisible wavelength range,
the second wavelength range of the second light source is a visible wavelength range, and
the light received by the second image sensor is a visible light in the visible wavelength range.

3. The image reading device according to claim 2,
wherein the processing circuitry is configured to detect the abnormal lighting of the first light source when an initial adjustment of the second image sensor is performed as the predetermined operation.

4. The image reading device according to claim 2,
wherein the processing circuitry is configured to detect the abnormal lighting of the second light source when an initial adjustment of the first image sensor is performed as the predetermined operation.

5. The image reading device according to claim 2,
wherein the processing circuitry is configured to detect the abnormal lighting of the first light source when an adjustment of the second image sensor is performed as the predetermined operation.

6. The image reading device according to claim 2,
wherein the processing circuitry is configured to compare the signal level of the first image output by the first image sensor with reference dark-time data to detect the abnormal lighting of the first light source.

7. The image reading device according to claim 6,
wherein the processing circuitry is configured to detect the abnormal lighting of the first light source when only the second image sensor is turned on to perform reading operation.

8. An image forming apparatus comprising:
the image reading device according to claim 1; and
an image forming device to form an image.

9. An image reading method executed by an image reading device, the method comprising:
with a first light source, irradiating an object with light in a first wavelength range;
with a first image sensor, receiving light emitted from the first light source to and reflected by the object to output a first image;
with a second light source, irradiating the object with light in a second wavelength range different from the first wavelength range of the first light source;
with a second image sensor, receiving light emitted from the second light source to and reflected by the object to output a second image;
calculating signal levels of the first image and the second image;
controlling light amounts of the first light source and the second light source respectively based on the calculated signal levels; and
detecting abnormal lighting of one of the first light source and the second light source corresponding to one of the first image sensor and the second image sensor that performs a predetermined operation.

10. The image reading method according to claim 9, wherein
the first wavelength range of the first light source is an invisible wavelength range,
the light received by the first image sensor is an invisible light in the invisible wavelength range,
the second wavelength range of the second light source is a visible wavelength range, and
the light received by the second image sensor is a visible light in the visible wavelength range.

11. The image reading method according to claim 10, wherein the detecting includes
detecting the abnormal lighting of the first light source when an initial adjustment of the second image sensor is performed as the predetermined operation.

12. The image reading method according to claim 10, wherein the detecting includes
detecting the abnormal lighting of the second light source when an initial adjustment of the first image sensor is performed as the predetermined operation.

13. The image reading method according to claim 10, wherein the detecting includes
detecting the abnormal lighting of the first light source when an adjustment of the second image sensor is performed as the predetermined operation.

14. The image reading method according to claim 10, further comprising:
comparing the signal level of the first image output by the first image sensor with reference dark-time data to detect the abnormal lighting of the first light source.

15. The image reading method according to claim 10, wherein the detecting includes
detecting the abnormal lighting of the first light source when only the second image sensor is turned on to perform reading operation.
